(19) United States
(12) Patent Application Publication
(10) Pub. No.: US 2012/0326659 A1
(43) Pub. Date: Dec. 27, 2012

(54) WIRELESS BATTERY CHARGER OF MOVING COIL TYPE

(75) Inventor: Rei SHUKUYA, Tokyo (JP)

(73) Assignee: TANASHIN DENKI CO., LTD., Tokyo (JP)

(21) Appl. No.: 13/492,915

(22) Filed: Jun. 10, 2012

(30) Foreign Application Priority Data
Jun. 21, 2011 (JP) 2011-136942

(51) Int. Cl. H02J 7/00

(52) U.S. Cl. 320/108

(57) ABSTRACT

The present invention discloses a wireless battery charger of moving coil type that moves a table (15) that mounts a transmitter coil (14) freely in an X-axis direction and in a Y-axis direction having a fixing guide (21), an X-axis slider (6) a Y-axis slider (9), a motor (10), a power transfer means (11) that transfers power of the motor to one of the X-axis slider or the Y-axis slider, a power distribution part (12) that distributes the power of the motor transferred to one slider to another slider, and the table (15) that mounts the transmitter coil (14) wherein the transmitter coil mounted on the table can move freely by transferring the power of the motor to both the one slider and the another slider. Therefore a structure of the battery charger can be simplified, the battery charger can be cheaper and electrical efficiency can be improved.

### CROSS-REFERENCES TO RELATED APPLICATIONS

The present application is related to the Japanese Patent Application No. 2011-136942, filed Jun. 21, 2011, the entire disclosure of which is expressly incorporated by reference herein.

### BACKGROUND OF THE INVENTION

1. Field of the Invention:

This invention relates to a wireless battery charger of moving coil type.

2. Description of the Related Art:

It is known that a wireless battery charger of moving coil type that detects a receiver coil included in a rechargeable battery when the rechargeable battery is placed on the battery charger, moves a table that mounts a transmitter coil freely in an X-axis direction and a Y-axis direction toward the receiver coil, and transfers electrical power from the transmitter coil to the receiver coil.

Various techniques are proposed for the wireless battery charger of moving coil type that enables the table with the transmitter coil to move freely in the X-axis direction and the Y-axis direction.

For example, Patent Cooperation Treaty application Publication No. 2010/150482 discloses the following battery charger.

In the above document, a wireless battery charger using a two dimensional moving mechanism is disclosed. The two dimensional moving mechanism is composed of an X-axis guide (6) that is placed parallel to an X-axis and has a rack (27), an X-axis slider (7) that is guided by the X-axis guide (6), a primary drive mechanism (8) that drives the X-axis slider, a Y-axis guide (9) that is placed parallel to a Y-axis, a Y-axis slider (10) that is guided by the Y-axis guide (9) and has a rack (47), and a secondary drive mechanism (11) that drives the Y-axis slider. In addition, the primary drive mechanism (8) is composed of a motor (30), a worm gear (32) and a pair of pinions (33, 34), and the secondary drive mechanism (11) is composed of a motor (50), a worm gear (52) and a pair of pinions (53, 54). Furthermore, a slider base (12) is attached to both the X-axis guide (6) and the Y-axis slider (10), a table body (13) is fixed on the slider base (12), and a coil (14) is mounted on an upper surface of the table body (13).

As described above, the wireless battery charger of moving coil type has a complex structure to enable the table body (13) with the coil (14) to move freely because the guides (6, 9), the sliders (7, 10) and the drive mechanisms (8, 11) should be adopted for each axis direction.

In addition, the guides (6, 9) are formed from a round metal bar and very expensive. The motors (30, 50) and the worm gears (32, 52) of the drive mechanisms (8, 11) are also expensive. Because the expensive components should be adopted for the X-axis direction and the Y-axis direction respectively, a device becomes expensive.

### BRIEF SUMMARY OF THE INVENTION

One aspect of the present invention provides a wireless battery charger of moving coil type, wherein
a two dimensional moving mechanism that mounts a transmitter coil of a wireless battery charger is placed in a lower case,
a circuit board is placed beneath an upper case,
the lower case is covered by the upper case,
when a rechargeable battery having a receiver coil is placed on an upper surface of the upper case, a position of the rechargeable battery is detected by the circuit board, the transmitter coil is moved close to the battery charger by using the two dimensional moving mechanism, and then the rechargeable battery is charged by supplying power from the transmitter coil to the rechargeable battery,
the two dimensional moving mechanism comprises:
   a fixing guide that is composed of a main guide and a sub guide placed parallel to one of an X-axis direction or a Y-axis direction;
   an X-axis slider that can move freely in the X-axis direction;
   a Y-axis slider that can move freely in the Y-axis direction;
   a motor that can drive both the X-axis slider and Y-axis slider simultaneously,
   a power transmission part that transfers power of the motor to one of the X-axis slider or the Y-axis slider;
   a power distribution part that distributes the power transferred to one slider from the motor to another slider; and
   a table that is fixed to the another slider and mounts the transmitter coil,
the one slider is attached to the fixing guide capable of moving freely in the X-axis direction or the Y-axis direction,
guide portions are formed parallel to a direction perpendicular to the fixing guide on a part of the one slider fixed to the fixing guide,
the another slider not attached to the fixing guide is attached to the one slider fixed to the fixing guide so as to move freely along the guide portions of the one slider,
a set of gears that is a part of the motor and the power transmission part is formed on the one slider,
the power of the motor is transferred to the one slider through the set of gears and transferred to the another slider through the power distribution part, and
the transmitter coil mounted on the table that is fixed to the another slider can move freely both in the X-axis direction and in the Y-axis direction.

The wireless battery charger of moving coil type in the present invention mounts a two dimensional moving mechanism wherein the one slider is attached to the fixing guide capable of moving freely in the X-axis direction or in the Y-axis direction, guide portions are formed parallel to a direction perpendicular to the fixing guide on a part of the one slider attached to the fixing guide, the another slider (that is not attached to the fixing guide) is attached to the one slider (that is attached to the fixing guide) so as to move freely along the guide portion of the one slider, a set of gears that is a part of the motor and the power transmission part is formed on the one slider, the power of the motor is transferred to the one slider through the set of gears and transferred to the another slider through the power transmission part, and the transmitter coil fixed to the another slider and mounts the table can move freely in the X-axis direction and in the Y-axis direction.

Therefore, although the table with the transmitter coil can move freely both in the X-axis direction and in the Y-axis direction, motors and metal guides are not required to be equipped respectively for each axis direction. A structure of the device can be simplified by using only one motor and only one metal guide for one of the axis directions. In addition, the device can be cheaper by reducing a number of the expensive motors and metal guides to be used.

Another alternative aspect of the present invention provides the wireless battery charger of moving coil type, wherein
the one slider is the Y-axis slider,
the another slider is the X-axis slider,
a salient portion is formed on one gear of the set of gears,
a groove parallel to the Y-axis direction is formed on a part of the X-axis slider, and
the power distribution part is formed by engaging the salient portion of the gears with the groove of the X-axis slider to transform rotating power of the set of gears to linear motion power in the X-axis direction by the salient portion and the groove.

By using the above configuration, the device can be further simplified.

Another alternative aspect of the present invention provides the wireless battery charger of moving coil type, wherein
the one slider is the X-axis slider,
the another slider is the Y-axis slider,
a salient portion is formed on one gear of the set of gears,
a groove parallel to the X-axis direction is formed on a part of the Y-axis slider, and
a power distribution part is formed by engaging the salient portion of the gears with the groove of the Y-axis slider to transform rotating power of the set of gears to linear motion power in the Y-axis direction by the salient portion and the groove.

By using the above configuration, the device can be further simplified.

### BRIEF DESCRIPTION OF THE DRAWINGS

FIG. 1 is a perspective view of a wireless battery charger of moving coil type and a rechargeable battery concerning the present invention.

FIG. 2 is an exploded perspective view of the wireless battery charger of moving coil type that mounts a two dimensional moving mechanism concerning the first embodiment.

FIG. 3 is a plane view showing a relation between a Y-axis slider and a fixing guide concerning the first embodiment.

FIG. 4 is a bottom view showing a power transmission part concerning the first embodiment.

FIG. 5 is an explanatory drawing showing a power distribution part concerning the first embodiment.

FIG. 6 is an explanatory drawing showing a power distribution part concerning the first embodiment.

FIG. 7 is an explanatory drawing showing a power distribution part concerning the first embodiment.

FIG. 8 is an exploded view showing a table concerning the first embodiment.

FIG. 9 is a perspective view showing a movement of the table concerning the first embodiment.

FIGS. 10A-10D are explanatory drawings showing a movement of the two dimensional moving mechanism concerning the first embodiment.

FIG. 11 is an explanatory drawing showing a track of the center of a transmitter coil concerning the first embodiment.

FIG. 12 is a plane view showing the wireless battery charger of moving coil type that mounts the two dimensional moving mechanism concerning the second embodiment.

### DETAILED DESCRIPTION OF THE INVENTION

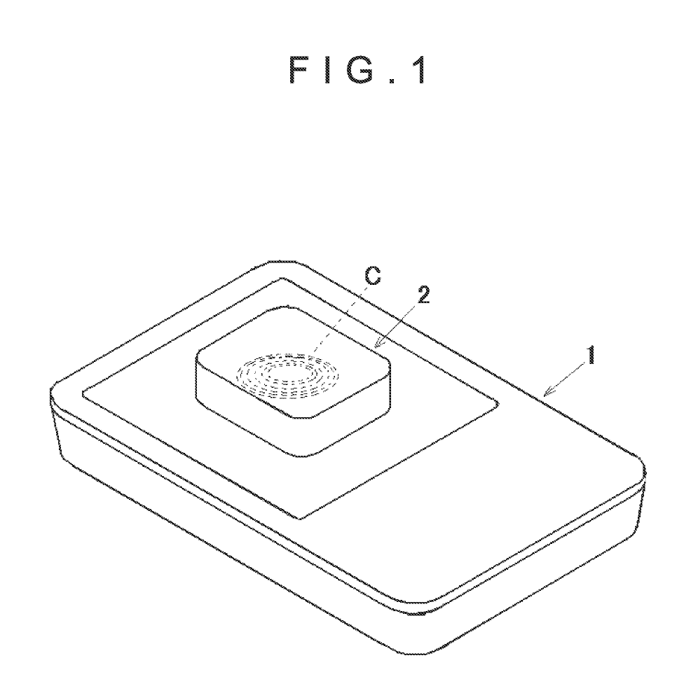

A preferred embodiment of the present invention will be described below with reference to figures. FIG. 1 is a perspective view of a wireless battery charger 1 of moving coil type and a rechargeable battery 2 that includes a receiver coil C of an electronic device concerning the present invention.

The wireless battery charger 1 can transfer electrical power from the wireless battery charger 1 to the rechargeable battery 2 to charge the rechargeable battery 2 only by placing the rechargeable battery 2 on an upper side of the wireless battery charger 1 without connecting them by a connector or the like. Various methods can be used to transfer the electrical power from the wireless battery charger to the rechargeable battery. In the embodiments of the present invention, coils are installed on the battery charger side (transmitter side) and the rechargeable battery side (receiver side) respectively, and the electrical power of the battery charger is transferred to the rechargeable battery to charge the rechargeable battery by using magnetic induction of the coils. The details will be explained later. Note that the method to transfer the electrical power to the rechargeable battery 2 is not limited to the above described method.

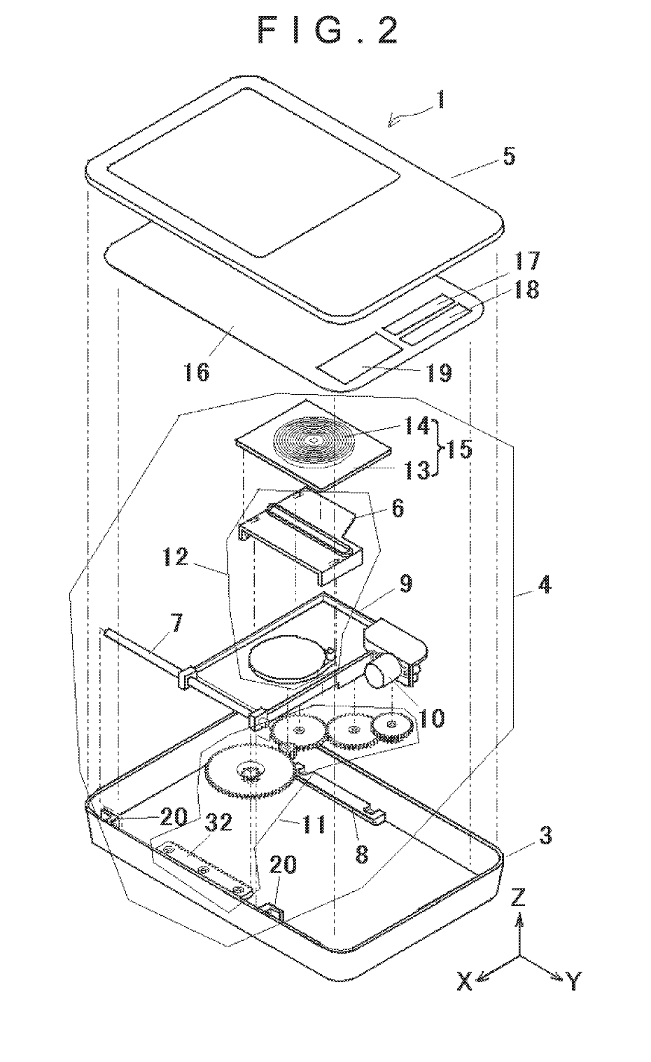

FIG. 2 shows the wireless battery charger 1 of moving coil type that mounts a two dimensional moving mechanism concerning the first embodiment. As shown in FIG. 2, the wireless battery charger 1 is composed of a lower case 3 that is rectangle shape with four thin walls are formed upward on four sides, a two dimensional moving mechanism 4 that is placed in the lower case 3, and a upper case 5 that covers over the lower case 3. The upper case 3 and the lower case 5 are connected by screws (not illustrated).

Arrows in FIG. 2 indicate axis directions: “X” indicates an X-axis direction, “Y” indicates a Y-axis direction and “Z” indicates a Z-axis direction.

The two dimensional moving mechanism 4 is composed of an X-axis slider 6 that can move freely in the X-axis direction, a main guide 7 and a sub guide 8 that are placed parallel to the Y-axis, a Y-axis slider 9 that is guided by the main guide 7 and the sub guide 8 so as to move freely in the Y-axis direction, a motor 10 that is mounted on the Y-axis slider 9, a power transmission part 11 that transfers the power of the motor 10 to the Y-axis slider 9, a power distribution part 12 that distributes the power transferred to the Y-axis slider 9 to the X-axis slider 6, a table body 13 that is fixed on the X-axis slider 6, and a transmitter coil 14 that is mounted on an upper surface of the table body 13. A table 15 is composed of the table body 13 and the transmitter coil 14.

A circuit board 16 is placed beneath the upper case 5.

The circuit board 16 has a drive control circuit 17 that controls driving of the power transmission part 11, a position detector circuit 18 that detects a position of the rechargeable battery 2 including the receiver coil C, and a charge control circuit 19 that detects completion of charging to stop charging the rechargeable battery 2.

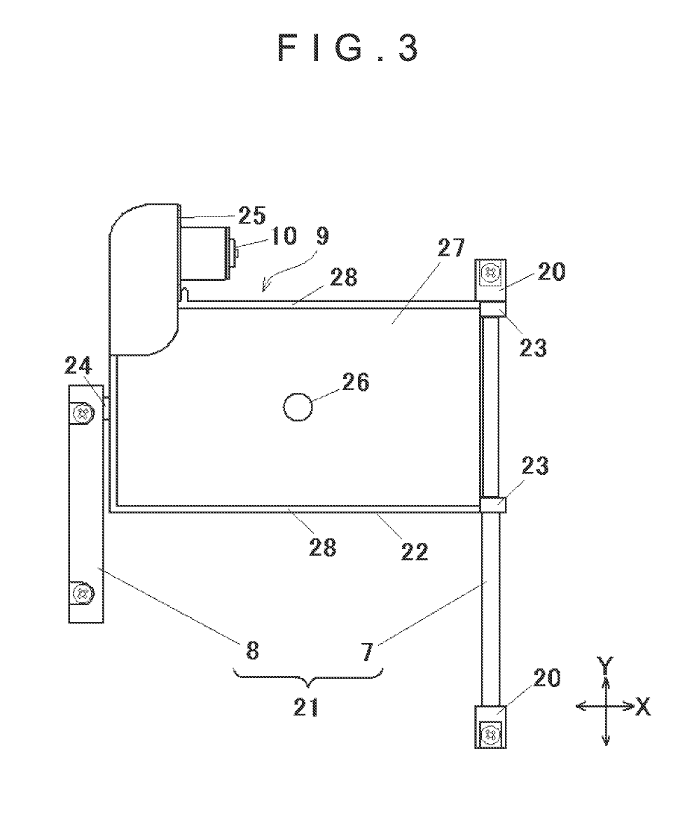

FIG. 3 shows the Y-axis slider 9 to be guided by the main guide 7 and the sub guide 8. As shown in FIG. 3, the main guide 7 is a round metal bar and both ends of the main guide 7 are inserted in fixing members 20, 20 respectively and fixed to the lower case 3 by screws. The sub guide 8 is made of synthetic resin and is fixed to the lower case 3 by screws. A fixing guide 21 is formed by the main guide 7 and the sub guide 8.

The Y-axis slider 9 has a base portion 22 that is long along the X-axis direction. A pair of first guide portions 23, 23 is formed at the right end (in FIG. 3) of the base portion 22 to insert the main guide 7. A second guide portion 24 is formed at the left end (in FIG. 3) of the base portion 22 to engage with the sub guide 8. A motor attaching portion 25 is formed at the upper left (in FIG. 3) of the base portion 22 to fix the motor 10. A through hole 26 is formed almost in the center of the base portion 22.

The surface of the base portion 22 forms a concave portion 27 in areas other than peripheral portions. In addition, both ends in the Y-axis direction of the base portion 22 (upper and lower ends in FIG. 3) form guide portions 28, 28 that are parallel to the X-axis direction.

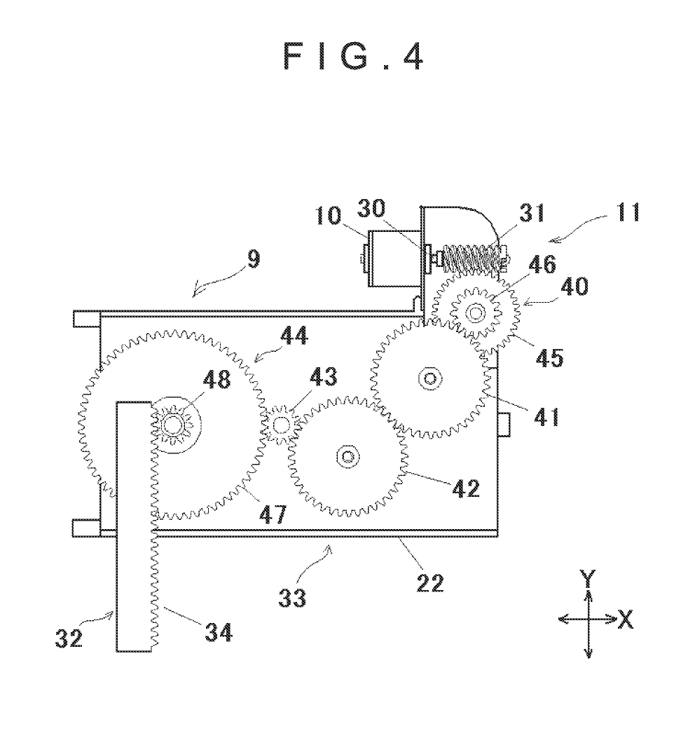

FIG. 4 shows the power transmission part 11 that is located on the bottom surface of the Y-axis slider 9. As shown in FIG. 4, the power transmission part 11 is composed of a worm gear 31 that is directly connected to a shaft 30 of the motor 10, a rack plate 32, and a set of gears 33 that are located between the worm gear 31 and the rack plate 32.

The rack plate 32 is formed long and narrow along the Y-axis direction and has a rack 34 on one side (right side in FIG. 4) in the longitudinal direction. As shown in FIG. 2, the rack plate 32 is fixed to the lower case 3 by screws (not illustrated).

The set of gears 33 is installed in the back side of the base portion 22 of the Y-axis slider 9, and is composed of a first gear 40, a second gear 41, a third gear 42, a fourth gear 43 and a fifth gear 44. The first gear 40 is a double gear comprising of a first stage gear 45 (lower in FIG. 4) that is a helical gear engaged with the worm gear 31, and a second stage gear 46 (upper in FIG. 4) that is a flat gear. The second gear 41, the third gear 42 and the fourth gear 43 are flat gears. The fifth gear 44 is a double gear comprising of a first stage gear 47 (lower in FIG. 4) that is engaged with the fourth gear 43, and a second stage gear 48 (upper in FIG. 4) that is engaged with the rack 34 of the rack plate 32. Both the first stage gear 47 and the second stage gear 48 of the fifth gear 44 are flat gears.

By adopting the above described configuration, when the motor 10 mounted on the Y-axis slider 9 is driven, the power of the motor 10 is transferred to the rack plate 32 fixed to the lower case 3 through the set of gears 33, and the Y-axis slider 9 can move freely in the Y-axis direction along the main guide 7 and the sub guide 8 (shown in FIG. 3) by a reaction force.

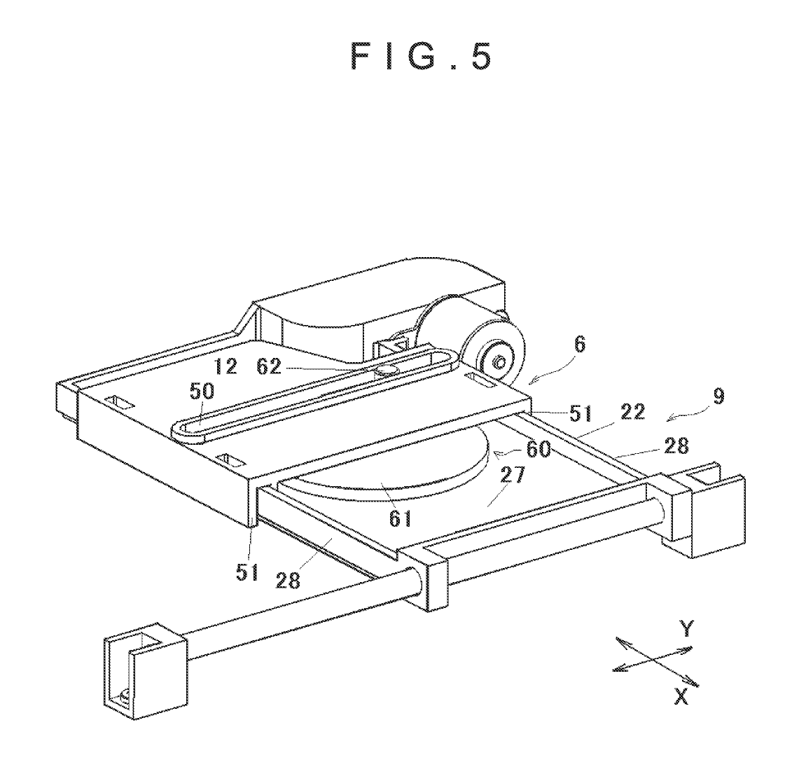

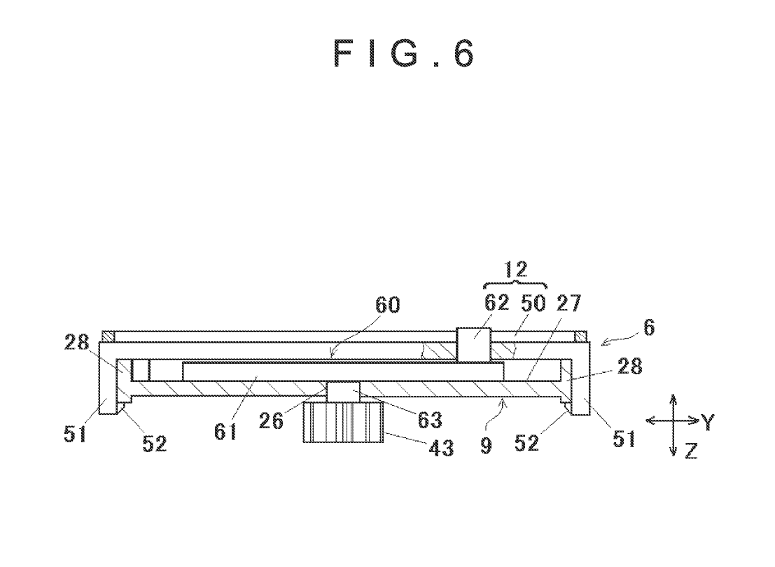

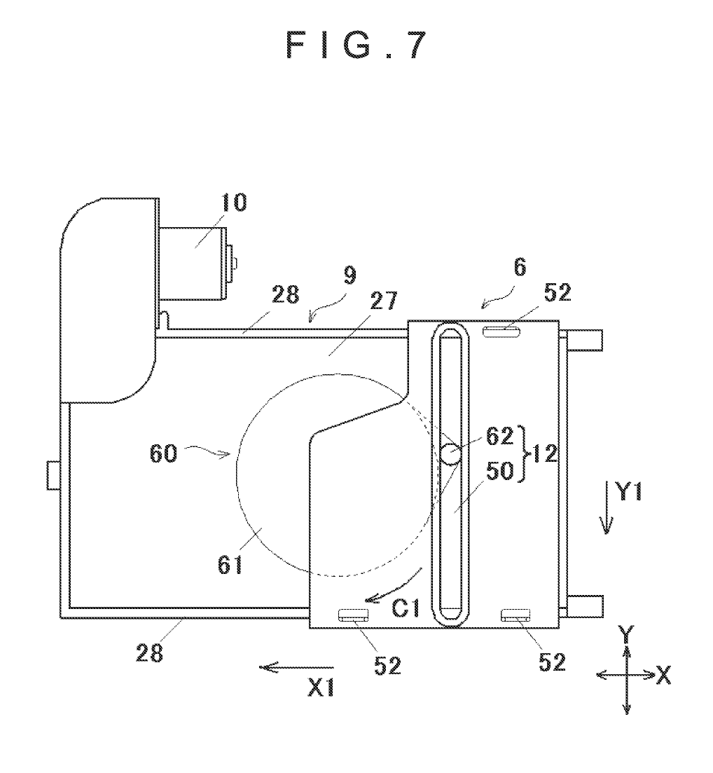

FIGS. 5-7 show relations among the X-axis slider 6, the Y-axis slider 7 and the power distribution part 12. FIG. 5 is a perspective view, FIG. 6 is a side view showing partly in cross section, and FIG. 7 is a front view. As shown in FIGS. 5-7, the X-axis slider 6 is located on the upper side of the Y-axis slider 9.

As shown in FIG. 7, the X-axis slider 6 is a rectangle shape except for one of the corners (upper left in FIG. 7) is missing, and a cam groove 50 is formed parallel to the Y-axis direction almost in the center of the X-axis slider 6. As shown in FIG. 6, guided portions 51, 51 protruding downward are formed at both ends in the Y-axis direction of the X-axis slider 6. As shown in FIG. 7, hooking portions 52, 52 directed inward are formed at three points of the lower end of the guided portions 51, 51.

The guided portions 51, 51 of the X-axis slider 6 are engaged with the guide portions 28, 28 of the Y-axis slider 9, and the hooking portions 52, 52 prevent the X-axis slider 6 from disconnecting to the Z-axis direction (vertical direction in FIG. 6). Therefore, the X-axis slider 6 can move freely on the Y-axis slider 9 in the X-axis direction (shown in FIG. 7) along the guide portions 28, 28. As explained above, by integrally forming the guide portions 28, 28 on the Y-axis slider 9, an expensive metal shaft that is conventionally required for the X-axis direction can be omitted.

As shown in FIG. 7, a link plate 60 is formed having a main portion 61 that is disk-shaped and made of synthetic resin, and a salient portion 62 that is located lateral to the main portion 61 and protruding upward (shown in FIG. 6). In addition, a shaft portion 63 protruding downward (shown in FIG. 6) is formed at a center of the main portion 61. As shown in FIG. 5, the link plate 60 is intermediate between the Y-axis slider 9 and the X-axis slider 6, and the link plate 60 is placed on the concave portion 27 of the Y-axis slider 9. As shown in FIG. 6, the shaft portion 63 is inserted to the through hole 26 of the Y-axis slider 9, a bottom surface of the main portion 61 is aligned with an upper surface of the concave portion 27 of the Y-axis slider 9, and then the shaft portion 63 is pressed into the fourth gear 43 that is a part of the set of gears 33. Therefore, the fourth gear 43 that is a part of the set of gears 33 is rotatable integrally with the link plate 60. In addition, the salient portion 62 of the link plate 60 is placed to engage with the cam groove 50 of the X-axis slider 6. The power distribution part 12 is formed by the salient portion 62 of the link plate 60 and the cam groove 50 of the X-axis slider 6.

If the motor 10 is driven, the set of gears 33 (shown in FIG. 4) rotates in sequence and the Y-axis slider 9 is moved in a direction of a Y1 arrow. Because the fourth gear 43 is a part of the set of gears 33, the link plate 60 rotates integrally with the fourth gear 43 when the set of gears 33 rotates. The link plate 60 rotates in a direction of a C1 arrow, the salient portion 62 pushes the cam groove 50 of the X-axis slider 6, and then the X-axis slider 6 is moved in a direction of an X1 arrow along the guide portions 28, 28 of the Y-axis slider 9. Although the motor 10 is only one, the power of the motor 10 is transferred to the Y-axis slider 9 to move the Y-axis slider 9, and the power is also distributed to the X-axis slider 6 by using the power distribution part 12. Consequently, the X-axis slider 6 and the Y-axis slider 9 can be moved simultaneously.

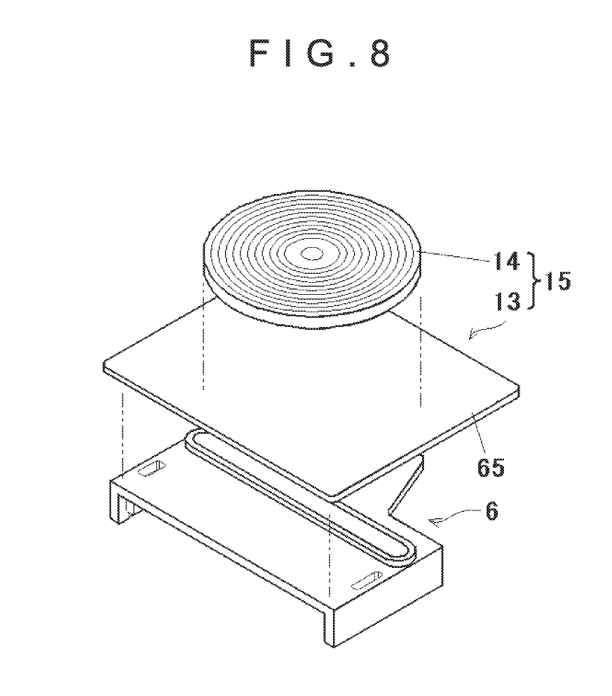

As shown in FIG. 8, the table body 13 has a base portion 65 of a rectangle shape. The transmitter coil 14 is mounted on an upper surface of the base portion 65. In addition, the base portion 65 is fixed to the X-axis slider 6 beneath the base portion 65. The method to mount the transmitter coil 14 on the table body 13 is not limited in a particular method. For example, the transmitter coil 14 can be mounted by using an adhesive material. The method to fix the table body 13 on the X-axis slider 6 is also not limited in a particular method. For example, the table body 13 can be fixed by forming hooks or the like at both ends of the base portion 65 and engaging the hooks with a part of the X-axis slider 6. Although not shown in the figures, a protective sheet or the like made from material having low friction or antistatic material can be attached on an upper surface of the transmitter coil 14 to prevent wearing and electrostatic charge caused by friction between the transmitter coil 14 and the circuit board 16.

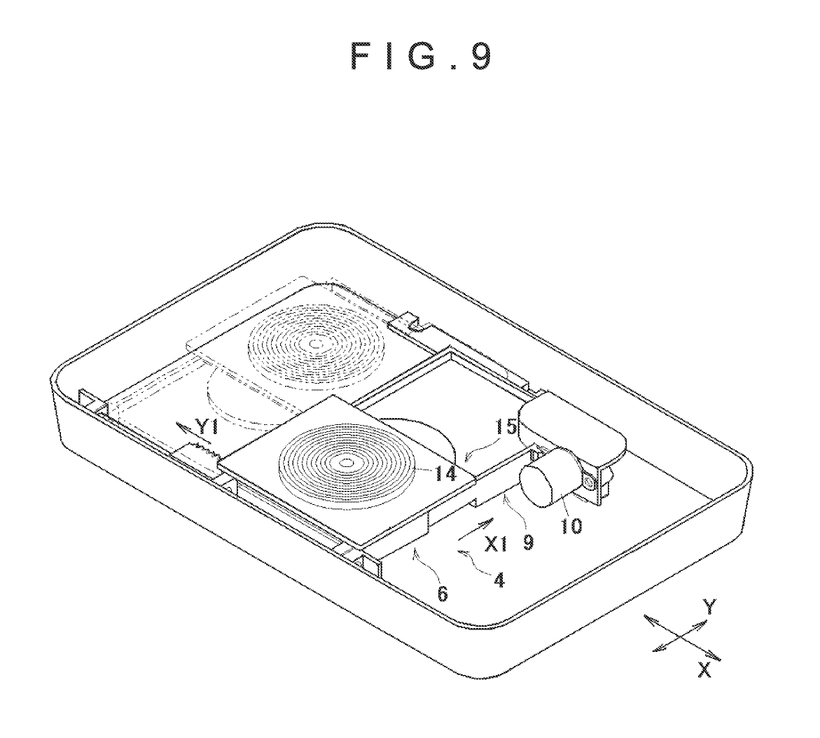

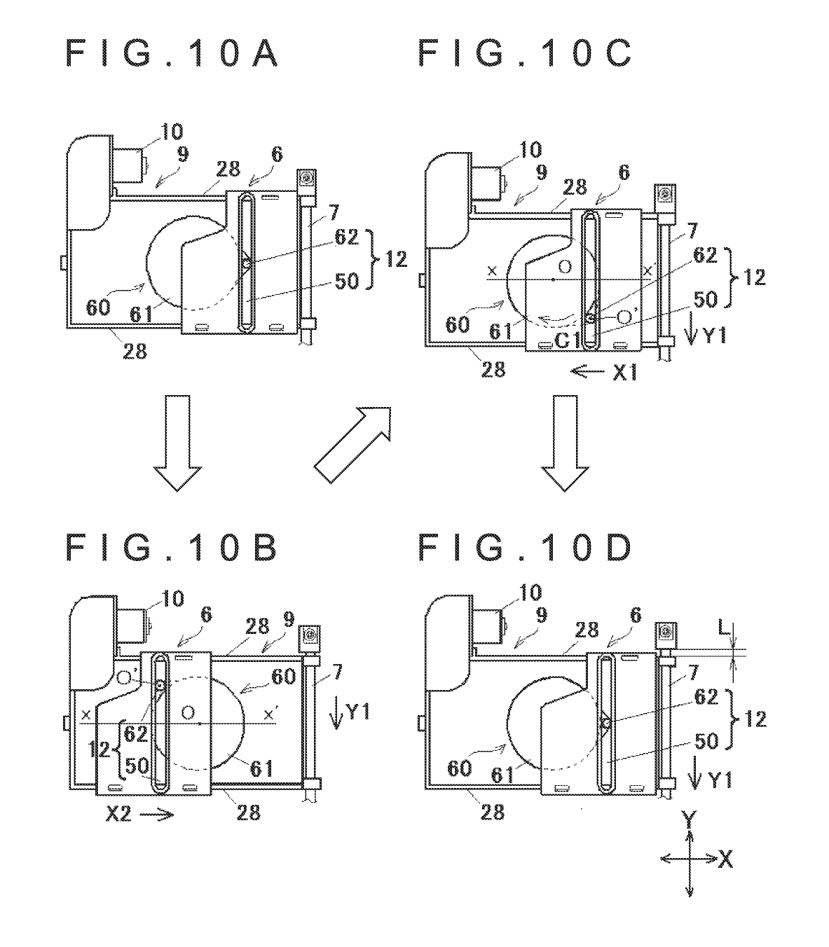

An operation of the two dimensional moving mechanism 4 will be described below with reference to FIGS. 9 and 10. FIG. 9 shows the transmitter coil 14 (shown as solid lines) located at a home position (near side in FIG. 9). At this state, if the rechargeable battery 2 is placed within a moving range (chargeable range) of the transmitter coil 14 as shown in FIG. 1, the position detector circuit 18 (shown in FIG. 2) detects the rechargeable battery 2. Then, the drive control circuit 17 (shown in FIG. 2) drives the motor 10 to move the transmitter coil 14 toward a position of the rechargeable battery 2.

The power of the motor 10 is transferred to the Y-axis slider 9 by the power transmission part 11 (shown in FIG. 4), and the Y-axis slider 9 is moved to the direction of the Y1 arrow. At the same time, the power of the motor 10 is also transferred to the X-axis slider 6 by the power distribution part 12 (shown in FIG. 7), and the X-axis slider 6 is moved to the direction of the X1 arrow.

In other words, the transmitter coil 14 fixed on the table 15 is moved together with the X-axis slider 6. When the transmitter coil 14 is moved to a desired position, the motor 10 is stopped by the drive control circuit 17 (shown in FIG. 2) and the transmitter coil 14 starts transferring the power to the rechargeable battery 2 to charge the rechargeable battery 2.

The position shown as broken lines in FIG. 9 is a position of the transmitter coil 14 opposite to the home position in the moving range of the transmitter coil 14. In the present embodiment, a distance between the home position of the transmitter coil 14 and the opposite position shown as broken lines is specified to 32 mm in the X-axis direction and 36 mm in the Y-axis direction. In other words, the moving range of the transmitter coil 14 is within the above specified range. Although the range is specified as described above, the range is not limited to the above specified value.

FIGS. 10A-10D show a movement of the two dimensional moving mechanism 4 to explain a function of the power transmission part 11 and movements of the X-axis slider 6 and the Y-axis slider 9. FIG. 10A is the home position and the link plate 60 rotates clockwise to the position of FIG. 10B, FIG. 10C, and then FIG. 10D. The link plate 60 rotates approximately one turn from the position of FIG. 10A to the position of FIG. 10D. When the link plate 60 rotates one turn, the X-axis slider 6 is reciprocated once in the X-axis direction along the guide portions 28, 28 of the Y-axis slider 9.

A center point of the main portion 61 of the link plate 60 is shown as “O”, while a center point of the salient portion 62 is shown as “O′” (shown in FIGS. 10B and 10C). In FIGS. 10B and 10C, a line x-x′ is shown. The line goes through the center point of the main portion 61 and is parallel to the X-axis direction.

If the motor 10 is driven from the home position shown in FIG. 10A, the X-axis slider 6 and the Y-axis slider 9 start moving by the power transmission part 11. As shown in FIG. 10B, if the power is transferred from the power transmission part 11 to the link plate 60, the link plate 60 rotates clockwise (in the direction of the C1 arrow), the salient portion 62 of the link plate 60 pushes the cam groove 50 of the X-axis slider 6, and then the X-axis slider 6 is moved in the direction of the X1 arrow along the guide portions 28, 28 of the Y-axis slider 9. At the same time, the Y-axis slider 9 is moved in the direction of the Y1 arrow along the main guide 7 and the sub guide 8 (shown in FIG. 3).

As shown in FIG. 10B, the X-axis slider 6 is moved in the direction of the X1 arrow when the center point O′ of the salient portion 62 is below the line x-x′. As shown in FIG. 10C, the X-axis slider 6 is moved to the direction of an X2 arrow when the center point O′ of the salient portion 62 is above the line x-x′.

When the link plate 60 rotates to the position shown in FIG. 10D, it means that the link plate 60 rotates one turn from the position shown in FIG. 10A and the X-axis slider 6 is reciprocated once in the X-axis direction. When the link plate 60 rotates one turn or the X-axis slider 6 is reciprocated once, the Y-axis slider 9 is moved a distance of “L” in the Y1 direction. In the present embodiment, a movement distance L is specified to approximately 2 mm.

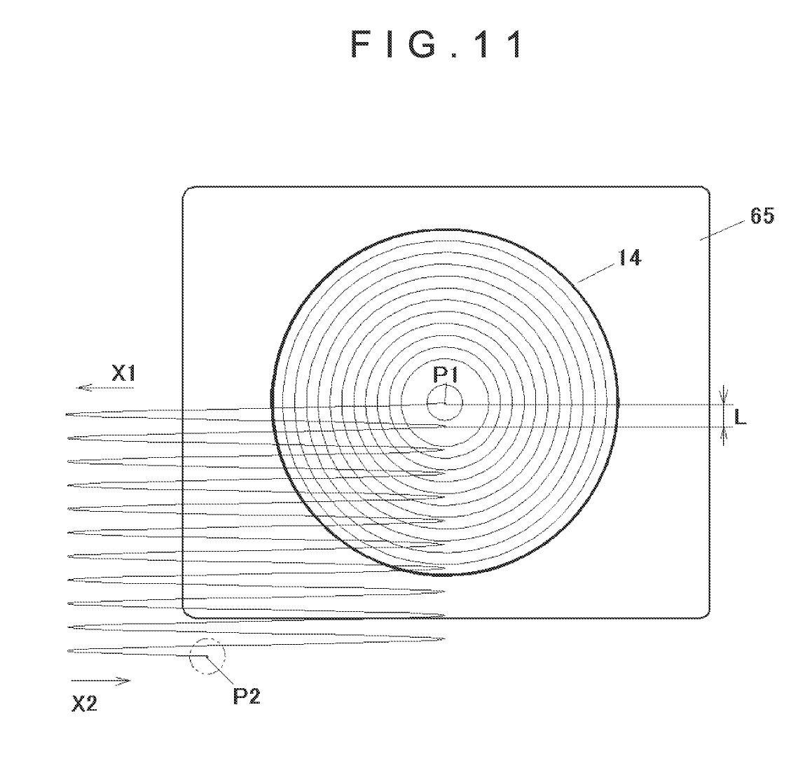

FIG. 11 shows a track of a center point of the transmitter coil 14 when the transmitter coil 14 is moved. As described above, the transmitter coil 14 is fixed to the base portion 65 of the table body 13, and the table body 13 is mounted on the X-axis slider 6 (shown in FIG. 8). As shown in FIG. 11, when the center point of the transmitter coil 14 is located at a home position P1 and the rechargeable battery 2 is placed on a point P2 that is within the moving range of the transmitter coil 14, the drive control circuit 17 starts operating to drive the motor 10. Note that the point P2 is supposed to be the center point of the transmitter coil 14 included in the rechargeable battery 2.

As a result, the point P2 of the rechargeable battery 2 is detected by the position detector circuit 18, and then the transmitter coil 14 is moved sinusoidally in the X-axis direction and in the Y-axis direction until the center point of the transmitter coil 14 reaches near the point P2. After that, the transmitter coil 14 starts transferring the power to the rechargeable battery 2.

As described above, a method using the magnetic induction (magnetic induction method) is used to transfer the power of the battery charger to the rechargeable battery in the present embodiment. In the magnetic induction method, the power transmission is effective when the center of the transmitter coil (battery charger) and the center of the receiver coil (rechargeable battery) are coincided. However, an amount of the power transmission reduces and the efficiency decreases as the centers of each coil become apart. In other words, when the rechargeable battery 2 is placed within the moving range of the transmitter coil 14, a low effective range of the power transmission is spread as the movement distance L of the Y-axis slider 9 becomes longer because coincidence between the center of the transmitter coil 14 (battery charger) and the center of the receiver coil C (rechargeable battery) become difficult.

Therefore, the movement distance L of the Y-axis slider 9 while the X-axis slider 6 is reciprocated once should be shorter from the viewpoint of the efficiency of the power transmission. The movement distance L should be no more than approximately 2 mm as described in the present embodiment. However, the movement distance L is not limited to the above described value.

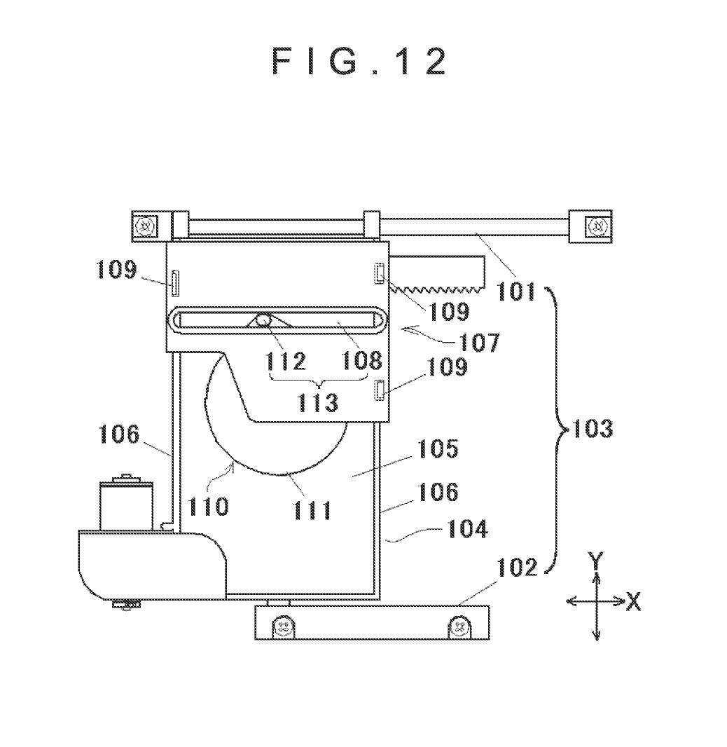

The second embodiment will be described below with reference to FIG. 12. FIG. 12 shows the two dimensional moving mechanism concerning the second embodiment. The difference from the first embodiment is only that angle is rotated by 90 degrees. In other words, only the X-axis direction and the Y-axis direction are switched from the first embodiment, but the components of the device are same as the first embodiment.

As shown in FIG. 12, a main guide 101 and a sub guide 102 are respectively placed parallel to the X-axis direction to form a fixing guide 103. The main guide 101 and the sub guide 102 are fixed to the lower case (not illustrated).

An X-axis slider 104 is guided by the main guide 101 and the sub guide 102, and can move freely in the X-axis direction. The X-axis slider 104 has a base portion 105 that is long along the Y-axis direction. In addition, both ends in the X-axis direction of the base portion 105 (left and right ends in FIG. 12) form guide portions 106, 106 that are parallel to the Y-axis direction.

A Y-axis slider 107 is located on the upper side of the X-axis slider 104. The Y-axis slider 107 is a rectangle shape except for one of the corners (lower left in FIG. 12) is missing, and a cam groove 108 is formed parallel to the X-axis direction almost in the center of the Y-axis slider 107. In addition, guided portions 109, 109 are formed at both ends in the X-axis direction of the Y-axis slider 107. The guided portions 109, 109 of the Y-axis slider 107 are engaged with the guide portions 106, 106 of the X-axis slider 104. Therefore, the Y-axis slider 107 can move freely in the Y-axis direction along the guide portions 106, 106.

A link plate 110 is formed having a main portion 111 that is disk-shaped, and a salient portion 112 that is located lateral to the main portion 111 and protruding upward. The link plate 110 is intermediate between the X-axis slider 104 and the Y-axis slider 107, and is rotatably placed on the base portion 105 of the X-axis slider 104. In addition, the salient portion 112 of the link plate 110 is engaged with the cam groove 108 of the Y-axis slider 107. A power distribution part 113 is formed by the salient portion 112 and the cam groove 108. The link plate 110 has a shaft portion (not illustrated), and the shaft portion is inserted to a through hole (not illustrated) of the X-axis slider 104. In addition, the shaft portion is pressed into one gear of a set of gears (not illustrated) and is rotatable integrally with the gears.

By using the above configuration described in the first embodiment, although the table 15 can moved freely both in the X-axis direction and in the Y-axis direction, the required motor 10 is only one and the required main guide 7 made of metal is also only one for the Y-axis direction. Therefore a structure of the device can be simplified. In addition, by reducing a number of the expensive motor 10 and main guide 7 to be used, the device can be cheaper.

By using the following configuration, the device can be further simplified: the salient portion 62 is formed on the link plate 60 that is a part of the set of gears 33, the cam groove 50 is formed on the X-axis slider 104, and the power distribution part 12 is formed by engaging the salient portion 62 with the cam groove 50 to transform rotating power of the link plate 60 to linear motion power in the X-axis direction by the salient portion 62 and the cam groove 50.

By using the following configuration described in the second embodiment, the device can be simplified as well as the first embodiment even though an angle is rotated by 90 degrees and the X-axis direction and the Y-axis direction are switched: the salient portion 112 is formed on the link plate 110 that is a part of the set of gears, the groove 108 is formed on the Y-axis slider 107, and the power distribution part 113 is formed by engaging the salient portion 112 with the cam groove 108 to transform rotating power of the link plate 110 to linear motion power in the axis direction by the salient portion 112 and the cam groove 108.

In the present embodiment, the rechargeable battery is placed on the upper surface of the upper case. However, an object is not limited to a stand-alone rechargeable battery. The present invention can be applied to any devices that include a receiver coil such as a mobile phone, a potable music player, or a portable game machine.

Note that, this invention is not limited to the above-mentioned embodiments. Although it is to those skilled in the art, the following are disclosed as the one embodiment of this invention.
Mutually substitutable members, configurations, etc. disclosed in the embodiment can be used with their combination altered appropriately.
Although not disclosed in the embodiment, members, configurations, etc. that belong to the known technology and can be substituted with the members, the configurations, etc. disclosed in the embodiment can be appropriately substituted or are used by altering their combination.
Although not disclosed in the embodiment, members, configurations, etc. that those skilled in the art can consider as substitutions of the members, the configurations, etc. disclosed in the embodiment are substituted with the above mentioned appropriately or are used by altering its combination.

While the invention has been particularly shown and described with respect to preferred embodiments thereof, it should be understood by those skilled in the art that the foregoing and other changes in form and detail may be made therein without departing from the sprit and scope of the invention as defined in the appended claims.

1. A wireless battery charger (1) of moving coil type, comprising a lower case (3);
an upper case (5) that covers over the lower case;
a two dimensional moving mechanism (4) that is placed in the lower case and mounts a transmitter coil (14) of the wireless battery charger; and
a circuit board (16) that is placed beneath the upper case, wherein
when a rechargeable battery (2) having a receiver coil (C) is placed on an upper surface of the upper case, a position of the rechargeable battery is detected by the circuit board, the transmitter coil is moved close to the rechargeable battery by using the two dimensional moving mechanism, and then the rechargeable battery is charged by supplying power from the transmitter coil to the rechargeable battery,
the two dimensional moving mechanism comprises:
a fixing guide (21, 103) that is composed of a main guide (7, 101) and a sub guide (8, 102) placed parallel to one of an X-axis direction or a Y-axis direction;
an X-axis slider (6, 104) that can move freely in the X-axis direction;
a Y-axis slider (9, 107) that can move freely in the Y-axis direction;
a motor (10) that can drive both the X-axis slider and Y-axis slider simultaneously;
a power transmission part (11) that transfers power of the motor to one of the X-axis slider or the Y-axis slider;
a power distribution part (12, 113) that distributes the power transferred to one slider from the motor to another slider; and
a table (15) that is fixed to the another slider and mounts the transmitter coil,
the one slider is attached to the fixing guide so as to move freely in the X-axis direction or the Y-axis direction,
guide portions (28, 28, 106, 106) are formed parallel to a direction perpendicular to the fixing guide on a part of the one slider fixed to the fixing guide,
the another slider not attached to the fixing guide is attached to the one slider fixed to the fixing guide so as to move freely along the guide portions of the one slider,
a set of gears (33) that is a part of the motor and the power transmission part is formed on the one slider,
the power of the motor is transferred to the one slider through the set of gears and transferred to the another slider through the power distribution part, and
the transmitter coil mounted on the table that is fixed to the another slider can move freely both in the X-axis direction and in the Y-axis direction.

2. The wireless battery charger of moving coil type according to claim 1, wherein:
the one slider is the Y-axis slider (9),
the another slider is the X-axis slider (6), and
a salient portion (62) is formed on a part of the set of gears,
a cam groove (50) parallel to the Y-axis direction is formed on a part of the X-axis slider, and
the power distribution part (12) is formed by engaging the salient portion of the gears with the groove of the X-axis slider to transform rotating power of the set of gears to linear motion power in the X-axis direction by the salient portion and the groove.

3. The wireless battery charger of moving coil type according to claim 1, wherein:
the one slider is the X-axis slider (104),
the another slider is the Y-axis slider (107),
a salient portion (112) is formed on a part of the set of gears,
a cam groove (108) parallel to the X-axis direction is formed on a part of the Y-axis slider, and
the power distribution part (113) is formed by engaging the salient portion of the gears with the cam groove of the Y-axis slider to transform rotating power of the set of gears to linear motion power in the Y-axis direction by the salient portion and the groove.
